(19) United States
(12) Patent Application Publication
(10) Pub. No.: US 2026/0100070 A1
(43) Pub. Date: Apr. 9, 2026

(54) EYE REFLECTIONS BASED IMPROVED PASSIVE LIVENESS DETECTION

(71) Applicant: EDGEVERVE SYSTEMS LIMITED, Bangalore (IN)

(72) Inventors: Ramprasath GANESARAJA, Mahindra City (IN); Swathika Nakulan, Chennai (IN); Rahul Das, Chennai (IN); Hannah Dotris S, Chennai (IN); Saravanan A P, Chennai (IN); Abhijith Tirupati Lokapur, Mysuru (IN); Tamilzhselvan Gnanasekaran, Chennai (IN)

(21) Appl. No.: 18/981,587

(22) Filed: Dec. 15, 2024

(30) Foreign Application Priority Data
Oct. 3, 2024 (IN) 202441074689

(51) Int. Cl. G06V 40/40; G06V 10/56; G06V 10/70; G06V 40/18

(52) U.S. Cl. CPC G06V 40/45; G06V 10/56; G06V 10/70; G06V 40/193

(57) ABSTRACT

A system and a method for passive liveness detection is provided. The system may be configured to identify a color composition of an iris of a user. The system may further generate an adoptive color pattern on a display of a user device based on the identified color composition. Furthermore, the system may capture a reflected color pattern corresponding to the generated adoptive color pattern from the iris of the user. The system may further determine a rate of change of pattern associated with the generated adoptive color pattern and the reflected color pattern to calculate a liveness score. Based on at least the calculated liveness score, the system may determine a verification status of the user.

This application claims priority to Indian Patent Application number 202441074689, filed on Oct. 3, 2024, which is hereby incorporated by reference in its entirety.

### TECHNOLOGICAL FIELD

The present disclosure generally relates to passive liveness detection. More particularly, the present disclosure relates to the passive liveness detection based on reflections from eyes of a user.

### BACKGROUND

As technology is advancing rapidly, different sectors such as financial, digital and government sectors are increasingly relying on remote user verification and/or facial authentication methods to verify identity of users. For example, the remote user verification may be utilized for different applications such as initiating transactions, account access, and other secure interactions.

Conventionally, the remote user verification may be performed by use of liveness detection methods such as active liveness test and passive liveness test. The active liveness test may require the user to perform specific actions or prompts in front of an imaging sensor (such as a camera), for example, blinking, smiling, following on-screen prompts, and so forth. User responses to such prompts may be analyzed to determine if the user is a real person and not a static image or a pre-recorded video. However, the active liveness test may have their own limitations. For instance, performing the actions may be inconvenient for the user, such as when the actions may be complex or repetitive in nature. Moreover, performing the actions may be intrusive for the users in public settings. Additionally, the active liveness test may fail in case of synthetic media such as spoofed images or deepfakes that may be able to mimic the user.

Furthermore, the passive liveness test may involve analyzing subtle features of a face or body of the user. For example, facial blood flow of the face may be analyzed as the static or the spoofed images may lack such a characteristic. In another example, microscopic movements that may be undetectable by naked eyes (such as minute eyebrow movements, muscle movements, etc.) may be detected using algorithms in the passive liveness test. However, the passive liveness test may be unreliable and inaccurate as the subtle movements may be mimicked by the deepfakes using advanced technology, such as artificial intelligence.

In view of light of the foregoing discussion, systems and methods may be required to overcome the drawbacks associated with the conventional methods.

The information disclosed in this background of the disclosure section is only for enhancement of understanding of the general background of the technology and should not be taken as an acknowledgement or any form of suggestion that this information forms the prior art already known to a person skilled in the art.

### SUMMARY

In an embodiment, the present disclosure discloses a system for passive liveness detection. The system may include a processor and a memory communicatively coupled to the processor. The memory stores processor-executable instructions, which, on execution, causes the processor to identify a color composition of an iris of a user. The processor may be further configured to generate an adoptive color pattern on a display of a user device based on the identified color composition. The processor may be further configured to capture a reflected color pattern corresponding to the generated adoptive color pattern from the iris of the user. The processor may be further configured to determine a rate of change of pattern associated with the generated adoptive color pattern and the reflected color pattern to calculate a liveness score. The processor may be further configured to determine a verification status of the user based on at least the calculated liveness score.

In some embodiments, the processor may be configured to capture a plurality of images of a face of the user via an imaging sensor of the user device. The processor may further determine eye coordinates from the plurality of images, to locate the iris of the user.

In accordance with some embodiments, the processor may be further configured to perform pixel analysis of the located iris to identify the color composition of the iris of the user.

In accordance with some embodiments, the processor may be configured to utilize a machine learning (ML) model to generate the adoptive color pattern based on the identified color composition of the iris, wherein the adoptive color pattern comprises a set of generated colors complementary to the color composition of the iris.

In accordance with some embodiments, the processor may be further configured to compute an average change in color between a set of generated colors in the adoptive color pattern and a corresponding set of reflected colors in the reflected color pattern. Based on a determination that the computed average change in color is found to be within a predefined range, the processor may determine the rate of change of pattern.

In accordance with some embodiments, the processor may be further configured to determine the rate of change of pattern based on a first set of time instants associated with the set of generated colors and a second set of time instants associated with the set of reflected colors.

In accordance with some embodiments, the processor may be configured to calculate the liveness score based on at least the determined rate of change of pattern, an overall threshold associated with a time delay between the first set of time instants and the second set of time instants, and an absolute threshold associated with the time delay between the first set of time instants and the second set of time instants.

In accordance with some embodiments, the processor may be configured to determine the verification status as a successful verification based on the calculated liveness score indicating the user as a live user.

In accordance with some embodiments, the processor may be configured to determine the verification status as a failed verification based on the calculated liveness score indicating the user as a spoofed user.

In accordance with some embodiments, the processor may be further configured to detect a blink pattern of eyes of the user based on a plurality of images of a face of the user. The processor may further determine the verification status of the user based on the detected blink pattern and the calculated liveness score.

In accordance with some embodiments, the processor may be further configured to compute an eye aspect ratio associated with the eyes of the user. The processor may further determine a set of variables based on the eye aspect ratio and the plurality of images of the user to detect the blink pattern.

In accordance with some embodiments, the processor may be further configured to match the detected blink pattern with a prestored blink pattern associated with the user. The processor may further determine the verification status as a successful verification based on successful matching of the detected blink pattern and the prestored blink pattern.

In another embodiment, the present disclosure discloses a method for passive liveness detection. The method may include identifying a color composition of an iris of a user. The method may further include generating an adoptive color pattern on a display of a user device based on the identified color composition. The method may further include capturing a reflected color pattern corresponding to the generated adoptive color pattern from the iris of the user. The method may further include determining a rate of change of pattern associated with the generated adoptive color pattern and the reflected color pattern to calculate a liveness score. The method may further include determining a verification status of the user based on at least the calculated liveness score.

In accordance with some embodiments, the method may further include capturing a plurality of images of a face of the user via an imaging sensor of the user device. The method may further include determining eye coordinates from the plurality of images, to locate the iris of the user.

In accordance with some embodiments, the method may further include performing pixel analysis of the located iris to identify the color composition of the iris of the user.

In accordance with some embodiments, the method may further include utilizing a ML model for generating the adoptive color pattern based on the identified color composition of the iris. The adoptive color pattern comprises a set of generated colors complementary to the color composition of the iris.

In accordance with some embodiments, the method may further include computing an average change in color between a set of generated colors in the adoptive color pattern and a corresponding set of reflected colors in the reflected color pattern. The method may further include determining the rate of change of pattern based on a determination that the computed average change in color is found to be within a predefined range.

In accordance with some embodiments, the method may further include determining the rate of change of pattern based on a first set of time instants associated with the set of generated colors and a second set of time instants associated with the set of reflected colors.

In accordance with some embodiments, the method may further include calculating the liveness score based on at least: the determined rate of change of pattern, an overall threshold associated with a time delay between the first set of time instants and the second set of time instants, and an absolute threshold associated with the time delay between the first set of time instants and the second set of time instants.

In yet another embodiment, the present disclosure discloses a non-transitory computer readable medium including instruction stored thereon that when processed by at least one processor cause an assessment system to perform operations. The operations may include identifying a color composition of an iris of a user. The operations may further include generating an adoptive color pattern on a display of a user device based on the identified color composition. The operations may further include capturing a reflected color pattern corresponding to the generated adoptive color pattern from the iris of the user. The operations may further include determining a rate of change of pattern associated with the generated adoptive color pattern and the reflected color pattern to calculate a liveness score. The operations may further include determining a verification status of the user based on at least the calculated liveness score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment of a system configured to perform passive liveness detection, in accordance with some embodiments of the present disclosure;

FIG. 2 illustrates a block diagram of the system of FIG. 1, in accordance with some embodiments of the present disclosure;

FIGS. 3A and 3B collectively illustrate an exemplary diagram depicting detailed steps for passive liveness detection, in accordance with some embodiments of the present disclosure;

FIG. 4 illustrates an exemplary scenario depicting utilization of a user device for passive liveness detection by a user, in accordance with some embodiments of the present disclosure;

FIG. 5 illustrates an exemplary diagram depicting blink pattern detection, in accordance with some embodiments of the present disclosure; and

FIG. 6 shows an exemplary flow chart illustrating a method for passive liveness detection, in accordance with some embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises.” does not, without more constraints, preclude the existence of other elements or additional elements in the system or apparatus.

Conjunctive language such as the phrase “at least one of X, Y or Z,” unless specifically stated otherwise, is to be understood to present that an item, term, etc. can be either X, Y, or Z, or a combination thereof.

Conjunctive language such as the phrase “at least one of X, Y and Z,” unless specifically stated otherwise, is to be understood to present that an item, term, etc. can be either X, Y, or Z, or a combination thereof.

Conventional liveness detection systems may include for instance, active liveness test and passive liveness test. The active liveness test may be complex in nature and may be intrusive for a user in public settings. Moreover, artificial intelligence (AI) based algorithms are increasingly used to produce deepfakes or spoofed images that may be able to mimic the users. In such cases, the active liveness test may fail to accurately identify that the user is a real person (such as a live user) or a spoofed image. The passive liveness test may rely on analyzing subtle features of a face or body of the user, such as facial blood flow and microscopic muscle movements. Such subtle features again may be mimicked using the deepfakes. Thus, using such conventional techniques of liveness detection may be unreliable and inaccurate in detection of the live user.

On the other hand, the proposed system of passive liveness detection offers an improvement over the existing art that may be successful in accurately determining the liveness of the user even in case of the deepfakes or spoofed images. The proposed system may focus on individual characteristics of the user to identify if the user may be a real person (such as a live user) or the spoofed image. For example, the proposed system may identify a color composition of iris of the user. Based on the identified color composition, the system may generate an adoptive color pattern to be shown on a display of a user device. The adoptive color pattern shown on the display may be reflected in the iris of the user. The system may further capture a reflected color pattern corresponding to the generated adoptive color pattern from the iris, and check if average change in color in the reflected color pattern lies within a predefined range in real-time or near real-time. In such a manner, by adapting to unique color characteristics of the user's iris, the system may assess the liveliness of the user by considering natural variations in the iris color and the background lighting of the user. Thus, the proposed system may help in distinguishing if the iris is a real iris (i.e., of the user) or a high-quality deepfake of an iris as the deepfake may be unable to show the required color variation corresponding to the adoptive color pattern in the real-time or the near real-time. Such a method may also provide reduction in a rate of false rejections of the user identity, thus improving the overall reliability of the system.

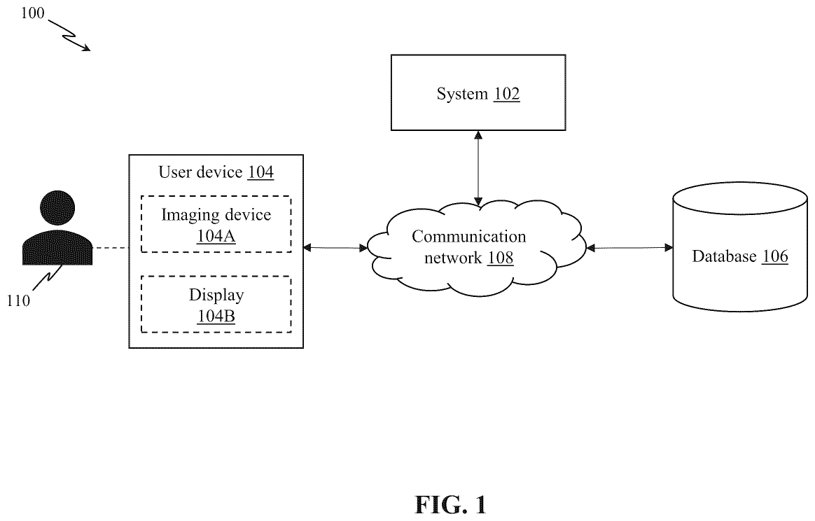

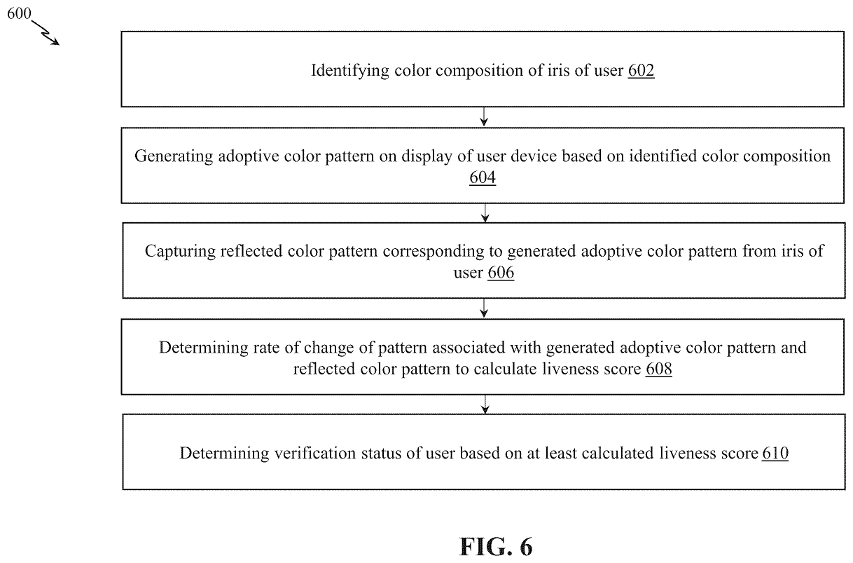

Further, the system may determine a rate of change of pattern associated with the generated adoptive color pattern and the reflected color pattern to determine if the user is the live user or the spoofed image. Typically, only a minute or a small difference may be observed between a time when the adoptive color pattern is generated on the display and the reflected color pattern is captured from the iris in the real-time or the near real-time, in case the user may be the live user. It may be practically impossible to mimic the adoptive color pattern observed on the display in the iris of the deepfakes in the real-time or the near real-time. Thus, by utilizing the rate of change of pattern, the proposed system may be able to accurately determine the liveness of the user. Furthermore, the proposed system may not require the user to perform any actions, thus, may be simple for the user to utilize, and may easily be used in the public spaces as well without being intrusive in nature. The determined liveness of the user may further be utilized in various applications. Details of the proposed system and method of the improved passive liveness detection are further described, for example, with respect to FIG. 1 till FIG. 6.

FIG. 1 illustrates an exemplary environment 100 of a system 102 configured to perform passive liveness detection, in accordance with some embodiments of the present disclosure. The environment 100 may include the system 102, a user device 104, a database 106 and a communication network 108. The user device 104 may further include an imaging sensor 104A and a display 104B. The user device 104 may be associated with a user 110.

The system 102 may include suitable logic, circuitry, code, and/or interfaces that may be configured to perform the passive liveness detection. For example, the system 102 may be configured to generate an adoptive color pattern on the display 104B based on a color composition of an iris of the user 110. The system 102 may be further configured to capture a reflected color pattern from the iris of the user 110. Further, the system 102 may determine a rate of change of pattern associated with the generated adoptive color pattern and the reflected color pattern to calculate a liveness score. Based on the liveness score, the system 102 may determine a verification status of the user 110 that may indicate that the user 110 may be a live user or a spoofed user. In some embodiments, the system 102 may also detect a blink pattern of the user 110 to determine the verification status of the user 110.

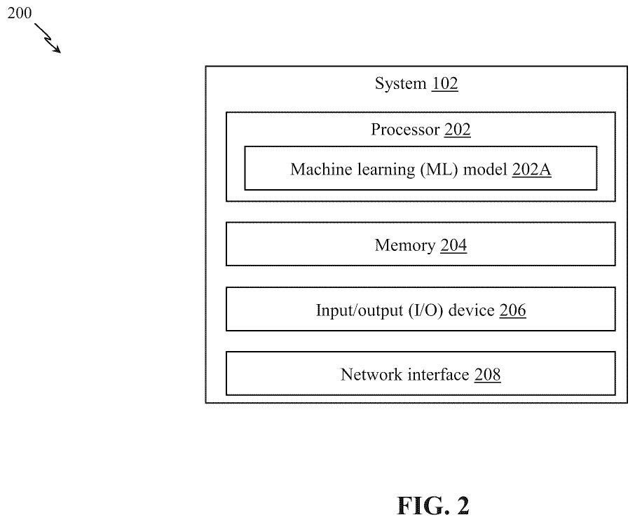

The system 102 may include components such as a processor, a memory, a communication interface and the like, that are further explained in FIG. 2. Examples of the system 102 may include, but are not limited to, an artificial intelligent (AI) machine, a computing device, a smartphone, a cellular phone, a mobile phone, a gaming device, a mainframe machine, a server, a computer work-station, a tablet computer, a laptop computer, a desktop computer, and/or a consumer electronic (CE) device.

The user device 104 may include suitable logic, circuitry, code, and/or interfaces that may be utilized by the user 110 for the passive liveness detection. The user device 104 may be utilized by the user 110 to provide inputs such as a plurality of images (e.g., a live or a real-time video) based on which the system 102 may perform the passive liveness detection. The user device 104 may further be utilized by the user 110 to obtain confirmation once the passive liveness detection may be successfully performed. Examples of the user device 104 may include, but are not limited to, the smartphone, the laptop computer, the desktop computer, the cellular phone, the mobile phone, the server, the AI machine, the computing device, the gaming device, the mainframe machine, the computer work-station, the tablet computer, and/or the CE device. In one or more embodiments, the system 102 may be a part of the user device 104.

The imaging sensor 104A of the user device 104 may be, for example, a camera. In an embodiment, the imaging sensor 104A may be the camera that may be configured to capture subjects based on visible light spectrum. In another embodiment, the imaging sensor 104A may be configured to capture the subjects in spectrums other than the visible light spectrum, for example, an infrared spectrum. The imaging sensor 104A may be utilized to capture the plurality of images of the user 110. Notably, the imaging sensor 104A may be utilized to specifically capture the plurality of images of a face of the user 110. Examples of the imaging sensor 104A may include, but are not limited to, a compact digital camera, a bridge camera, digital single-lens reflex camera, an action camera, a 360-degree camera, a smartphone camera, and a closed-circuit television (CCTV) camera.

The display 104B may be utilized to show the generated adoptive color pattern to the user 110. The user 110 may be required to face towards the display 104B and the imaging sensor 104A such that the generated adoptive color pattern may be seen by the user 110 and the reflected color pattern (corresponding to the generated adoptive color pattern) may be captured from the iris of the user 110. Examples of the display 104B may include, but are not limited to, a touch screen display, a foldable display, a liquid crystal display (LCD), and a light emitting diode (LED) display.

The database 106 may include suitable logic, circuitry, interfaces, and/or code that may be configured to store data such as a prestored blink pattern associated with the user 110, the verification status of the user 110 each time the user 110 utilizes the system 102, and the like. In an embodiment, the database 106 may be a vector database. In some embodiments, the database 106 may be a relational database. In other embodiments, the database 106 may be a non-relational database. Also, in some cases, the database 106 may be stored on a server, such as a cloud server or may be cached and stored on the system 102. In some embodiments, the server of the database 106 may be configured to receive a request to provide the prestored blink pattern to the system 102, via the communication network 108. In response to such request, the server of the database 106 may be configured to retrieve and provide the prestored blink pattern to the system 102, via the communication network 108. Additionally, or alternatively, the database 106 may be implemented using hardware including a processor, a microprocessor (e.g., to perform or control performance of one or more operations), a field-programmable gate array (FPGA), or an application-specific integrated circuit (ASIC). In some other instances, the database 106 may be implemented using a combination of hardware and software.

The communication network 108 may include a communication medium through which the system 102, the user device 104, and database 106 may communicate with each other. The communication network 108 may be one of a wired connection or a wireless connection. Examples of the communication network 108 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth® (BT) communication protocols.

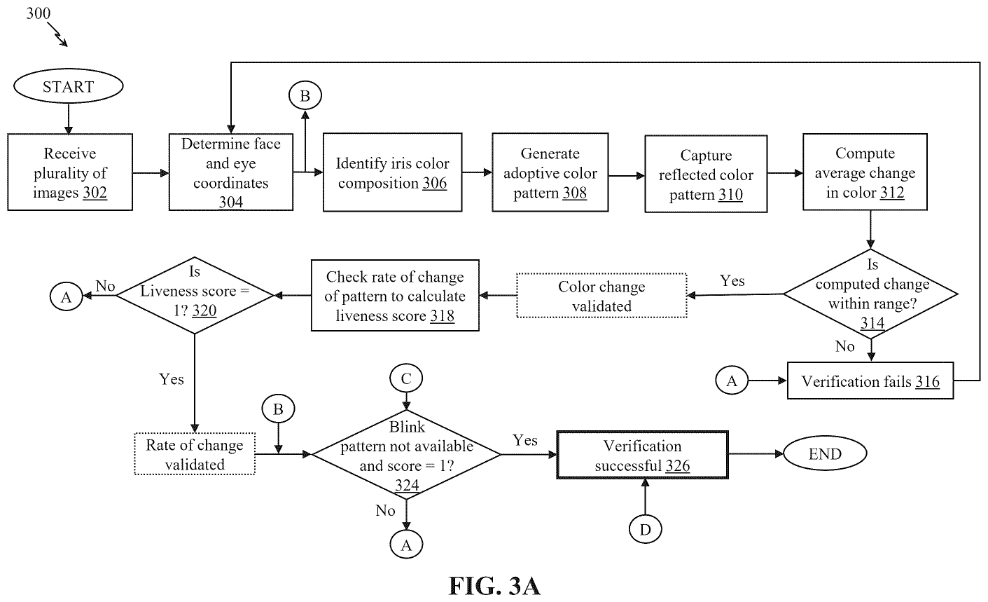

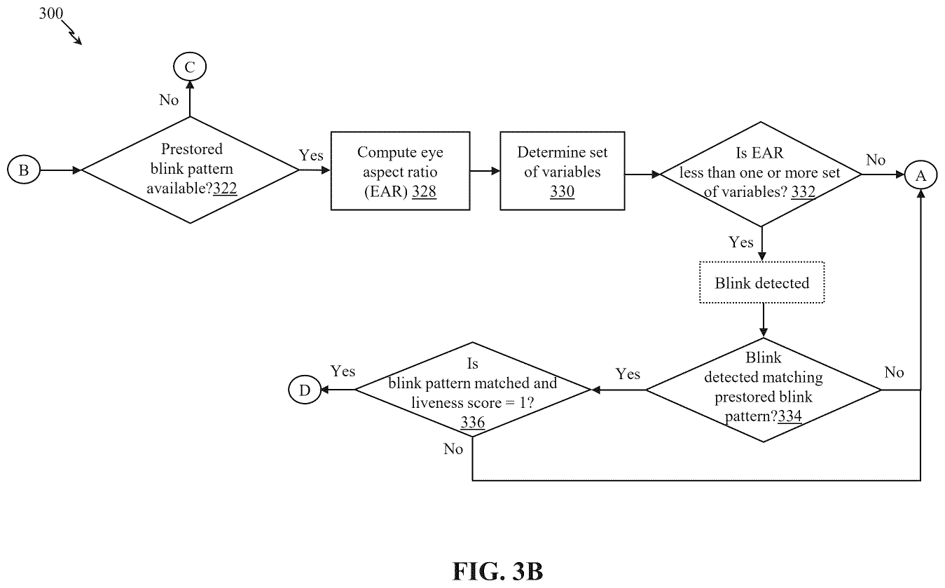

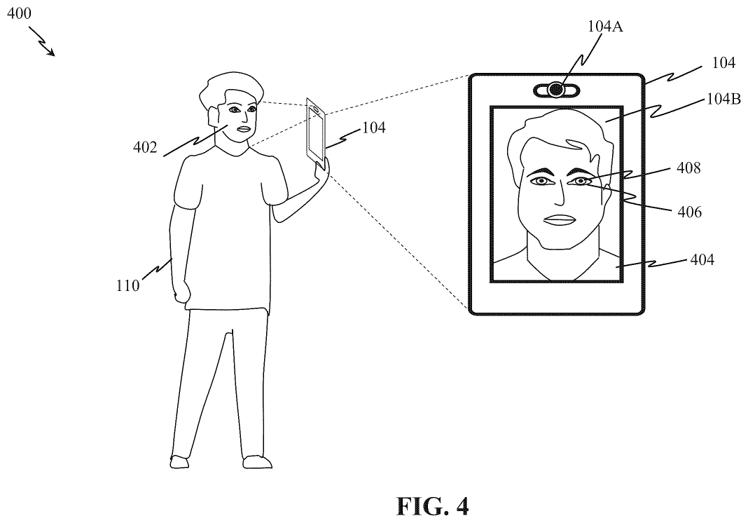

In operation, the system 102 may be required by the user 110 for remote authentication purpose. As an example, the user 110 may require performing the remote authentication for secure digital transactions. In such a scenario, the user device 104 may be utilized by the user 110. The user device 104 may be kept at such a position that the face of the user 110 may be in front of the imaging sensor 104A and the display 104B. The system 102 may first detect the facial landmarks or coordinates of the user 110 to determine location of eyes on the face of the user 110. Once the location of the eyes may be determined, the system 102 may identify a color composition of the iris of the user 110. Details of the identification of the color composition are further described, for example, in FIG. 3A and FIG. 4.

Based on the color composition of the iris, the system 102 may be configured to generate the adoptive color pattern on the display 104B of the user device 104. The generated adoptive color pattern may include a set of generated colors. When the adoptive color pattern may be generated on the display 104B, the reflection of the adoptive color pattern may fall on the iris of the user 110 in real-time, as the user 110 may be facing the display 104B. The system 102 may be configured to capture the reflected color pattern from the iris of the user 110 by use of the imaging sensor 104A. Details of the generation of the adoptive color pattern and capturing the reflected color pattern are further described, for example, in FIG. 3A.

It may be noted that in case the user 110 may be a live user, the set of generated colors in the generated adoptive color pattern and a corresponding set of reflected colors in the reflected color patter may be similar. Thus, in some embodiments, the system 102 may be further configured to compute an average change in color between the set of generated colors and the set of reflected colors. The system 102 may determine if the average change in color lies within a predefined range. It may be noted that, in case of the deepfakes, the reflected color patter may not be seen. Thus, the system 102 may utilize the average change in color to determine the liveness of the user 110. Details of computation of the average change in color are further described, for example, in FIG. 3A.

Based on a determination that the average change in color lies within the predefined range, the system 102 may determine a rate of change of pattern associated with the generated adoptive color pattern and the reflected color pattern to calculate a liveness score. It may be noted that even in a scenario where the deepfakes may be able to mimic the set of generated colors in the set of reflected colors, the rate of change of pattern may be impossible to occur in the real-time or the near real-time. Thus, the system 102 may utilize the rate of change of pattern in the real-time or the near real-time to determine the liveness of the user 110.

In some embodiments, the system 102 may calculate the liveness score based on the rate of change of pattern, that may indicate that the user 110 may be the live user or the spoofed user. In an example, the liveness score=1 may indicate the live user, and the liveness score=0 may indicate the spoofed user. The system 102 may determine a verification status of the user 110 as a successful verification based on the calculated liveness score=1. The system 102 may determine the verification status of the user 110 as a failed verification based on the calculated liveness score=0. Details of calculation of the liveness score and the determination of the verification status are further described, for example, in FIG. 3A.

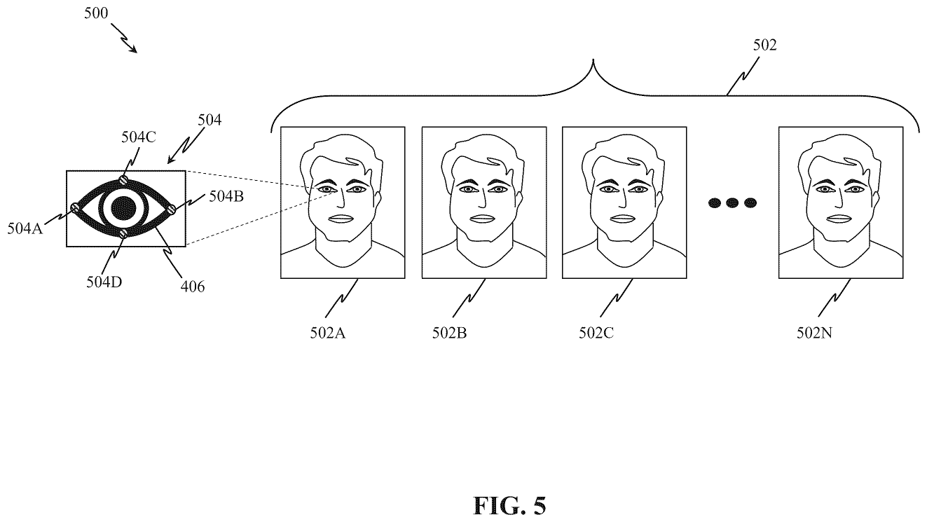

In some embodiments, the system 102 may further check if a prestored blink pattern associated with the user 110 may be available. In case the prestored blink pattern may be available, the system 102 may be further configured to detect the blink pattern of the eyes of the user 110. The system 102 may match the detected blink pattern with a prestored blink pattern. Based on a successful matching, the system 102 may determine the verification status as the successful verification. Thus, in case the prestored blink pattern may be available, the system 102 may utilize both the blink pattern detection and the determination of the rate of change of pattern for the liveness detection. Details of the blink pattern detection are further described, for example, in FIG. 3B and FIG. 5.

FIG. 2 illustrates a block diagram 200 of the system of FIG. 1, in accordance with some embodiments of the present disclosure. FIG. 2 is explained in conjunction with elements of FIG. 1. The system 102 may include a processor 202, a memory 204, an input/output (I/O) interface 206 and a communication interface 208. The processor 202 may further include a machine learning (ML) model 202A.

The processor 202 may include suitable logic, circuitry, and/or interfaces that may be configured to execute program instructions associated with different operations to be executed by the system 102. For example, some of the operations may include identifying the color composition of the iris of the user 110, generating the adoptive color pattern on the display 104B of the user device 104 based on the identified color composition, and capturing the reflected color pattern corresponding to the generated adoptive color pattern from the iris of the user 110. The operations may further include determining the rate of change of pattern associated with the generated adoptive color pattern and the reflected color pattern to calculate the liveness score and determining the verification status of the user based on at least the calculated liveness score.

The processor 202 may include one or more specialized processing units, which may be implemented as a separate processor. In an embodiment, the one or more specialized processing units may be implemented as an integrated processor or a cluster of processors that perform the functions of the one or more specialized processing units, collectively. The processor 202 may be implemented based on a number of processor technologies known in the art. Examples of implementations of the processor 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

In some embodiments, the ML model 202A may be configured to perform a task of generation of the adoptive color pattern based on the identified color composition of the iris of the user 110. In accordance with some embodiments, the processor 202 may be configured to pre-train the ML model 202A. In an embodiment, the ML model 202A may be a neural network model. Examples of the ML model 202A may include, but are not limited to, a convolutional neural network (CNN), a recurrent neural network (RNN), a radial basis function (RBF) network, a long short-term memory (LSTM) network, a multilayer perceptron (MLP) model, a generative adversarial network (GAN), and deep belief networks (DBN).

The memory 204 may include suitable logic, circuitry, and/or interfaces that may be configured to store the one or more instructions to be executed by the processor 202. In accordance with an embodiment, the memory 204 may be configured to store the prestored blink pattern associated with the user 110. In some embodiments, the memory 204 may store the ML model 202A utilized by the processor 202 for performing the task of generation of the adoptive color pattern. In an embodiment, the memory 204 may be configured to store all data that may be stored in the database 106 such as the color composition of the user 110, the verification status of the user 110 and the like that may be used in subsequent liveness detection tasks. In some embodiments, the database 106 may be communicatively coupled to the memory 204. In some cases, the database 106 and the memory 204 may be same. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, code, and/or interfaces that may be configured to receive an input from the user 110 and provide an output based on the received input. For example, the I/O device 206 may receive the input from the user 110 to start the liveness detection process. In one embodiment, the imaging sensor 104A and the display 104B may be a part of the I/O device 206. In such a case, the I/O device 206 may be configured to capture the plurality of images of the user 110 and output (or display) the adoptive color pattern to the user 110. Examples of the I/O device 206 may include, but are not limited to, a touch screen, a keyboard, an imaging sensor (such as the imaging sensor 104A), a mouse, a joystick, a microphone, a display device (such as the display 104B), and a speaker.

The network interface 208 may include suitable logic, circuitry, code, and/or interfaces that may be configured to facilitate communication between the processor 202, the user device 104 and the database 106 via the communication network 108. The network interface 208 may be implemented by use of various known technologies to support wired or wireless communication of the system 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as 5th generation (5G), Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

FIGS. 3A and 3B collectively illustrate an exemplary diagram 300 depicting detailed steps for passive liveness detection, in accordance with some embodiments of the present disclosure. FIGS. 3A and 3B are explained in conjunction with elements of FIG. 1 and FIG. 2.

As illustrated in FIGS. 3A and 3B, the exemplary diagram 300 may comprise one or more steps. The exemplary diagram 300 may start at step 302 and end at step 336. The exemplary diagram 300 may be described in the general context of computer executable instructions. Generally, computer executable instructions can include routines, programs, objects, components, data structures, procedures, modules, and functions, which perform particular functions or implement particular abstract data types.

The order in which the steps of the exemplary diagram 300 are described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 302, the plurality of images may be received. In accordance with some embodiments, the processor 202 may be configured to receive the plurality of images. For instance, the processor 202 may receive the plurality of images in form of a real-time video of the user 110. A scenario that depicts capturing the real-time video is described in FIG. 4. The reception of the plurality of images may be explained with reference to FIG. 4.

FIG. 4 illustrates an exemplary scenario 400 depicting utilization of the user device 104 for passive liveness detection by the user 110, in accordance with some embodiments of the present disclosure. FIG. 4 is explained in conjunction with elements of FIG. 1, FIG. 2, FIG. 3A and FIG. 3B.

The exemplary scenario 400 may include the user device 104 that may further include the imaging sensor 104A and the display 104B. The exemplary scenario 400 may further include the user 110. Further, the exemplary scenario 400 depicts a face 402 of the user 110, an image 404 of the plurality of images corresponding to the user 110, an eye 406 and an iris 408 of the user 110.

Referring to FIG. 4, the user device 104 (e.g., the smartphone) may be positioned by the user 110 in such a way that the imaging sensor 104A and the display 104B are at a level of the face 402 of the user 110. Further, a front profile of the face 402 of the user 110 may be front of the imaging sensor 104A and the display 104B. Such positioning may be required so that reflections may be captured from the iris 408 of the user, as will be explained further.

In some embodiments, the imaging sensor 104A may be configured to capture the plurality of images (such as the real-time video) of the face 406 of the user 110. In an embodiment, the processor 202 may be configured to trigger the imaging sensor 104A to capture the plurality of images. One image (such as the image 404) of the plurality of images is shown for explanation. The captured image 404 may be displayed on the display 104B.

Referring again to FIG. 3A, at step 304, eye coordinates may be determined. In some embodiments, the processor 202 may be configured to determine the eye coordinates of the user 110. The processor 202 may determine the eye coordinates from the plurality of images, to locate the iris 408 of the user 110. In an embodiment, the processor 202 may detect the face 402 and facial landmarks of the user 110 to determine the eye coordinates.

In some embodiments, the processor 202 may utilize an open-source software, such as an ML toolkit used for computer vision and image processing tasks. For example, the processor 202 may utilize a ‘Dlib’ library. For instance, face detector and shape predictor methods of the ‘Dlib’ library may be utilized to identify faces and specific facial landmarks within each detected face (such as the face 402), in each frame (e.g., the image 404) of the video (e.g., the plurality of images) respectively. For each detected face, the ‘Dlib’ library may specifically focus on regions corresponding to the eyes and extract the coordinates of left and right eye respectively. For example, the ‘Dlib’ library may focus on the eye region of the face 402 of the user 110 in the image 404 to determine the eye coordinates of the eye 406 of the user 110. In a preferred embodiment, the eye coordinates of both the eyes of the user 110 may be determined to locate the iris of both the eyes of the user 110.

At step 306, the color composition of the iris 408 of the user 110 may be identified. In accordance with some embodiments, the processor 202 may be configured to identify the color composition of the iris 408 of the user 110. Notably, the color composition of the iris of each individual may be different. The processor 202 may utilize such unique property of the iris 408 to perform the passive liveness detection for the user 110.

In some embodiments, the processor 202 may be configured to perform pixel analysis of the located iris 408 to identify the color composition of the iris 408 of the user 110. The color composition of the iris 408 may be determined by locating the iris 408 in the image 404 and then extracting color information from the iris 408. In an embodiment, the processor 202 may analyze Red Green Blue (RGB) values of pixels in region of the located iris 408 to extract the color information. Based on the extracted color information, the color composition of the iris 408 may be classified into different categories such as a blue color, a brown color, a green color, and the like. In one or more embodiments, the processor 202 may be configured to utilize other methods for the pixel analysis, such as analysis of Cyan Magenta Yellow Black (CMYK) values, Hue Saturation Values (HSV), Hue Saturation Lightness (HSL) values, ML based models for the pixel analysis and the like.

At step 308, the adoptive color pattern may be generated. In accordance with some embodiments, the processor 202 may be configured to generate the adoptive color pattern based on the identified color composition. The adoptive color pattern may be generated on the display 104B of the user device 104. The adoptive color pattern may be generated on the display 104B such as when the face 402 of the user 110 may be towards the display 104B, the reflections corresponding to the adoptive color pattern may be captured from the iris 408 of the user 110.

In some embodiments, the ML model may be utilized to generate the adoptive color pattern. In accordance with some embodiments, the processor 202 may be configured to utilize the ML model to generate the adoptive color pattern based on the identified color composition of the iris 408. The adoptive color pattern may include a set of generated colors complementary to the color composition of the iris 408. In an embodiment, the processor 202 may identify a dominant hue in the color composition of the iris 408 in an HSL color model. The processor 202 may further utilize the ML model that may be pre-trained to determine one or more complementary colors that may provide a strongest contrast in the reflections. In an example, the ML model may be a pre-trained CNN model. In one or more embodiments, the adoptive color pattern may include different patterns along with the set of generated colors.

By adapting to the unique color characteristics of the iris 408 of the user 110, the processor 202 may assess the liveliness of the user 110 by taking into account natural variations in the color composition of the iris 408 as well as background lighting conditions of the user 110. Thus, the processor 202 in such a manner may help distinguishing between a real iris (such as the iris 408) and a high-quality deepfake of the iris.

In an exemplary embodiment, the processor 202 may be configured to identify a unique pattern of the iris 408 of the user 110. For example, the unique pattern may include a unique combination of pigmented rings, crypts, furrows and the like. Based on the identified unique pattern of the iris 408, the processor 202 may generate the adoptive color pattern. Thus, by utilizing the unique pattern of the iris 408, the adoptive color pattern may be generated.

At step 310, the reflected color pattern may be captured. In accordance with some embodiments, the processor 202 may be configured to capture the reflected color pattern, i.e., the reflections from the iris 408 of the user 110 corresponding to the generated adoptive color pattern. The reflected color pattern may include a set of reflected colors. For instance, the imaging sensor 104A may capture the reflected color pattern based on the trigger received from the processor 202. It may be noted that the generation of the adoptive color pattern and the capture of the reflected color pattern may occur in the real-time or the near-real time.

At step 312, an average change in color may be computed between the set of generated colors in the adoptive color pattern and the corresponding set of reflected colors in the reflected color pattern. In accordance with some embodiments, the processor 202 may be configured to compute the average change in color between the set of generated colors and the corresponding set of reflected colors. It may be noted that, in case the user 110 may be the live user, the average change in color may be minimal, due to a fact that same (or similar) colors as that of the set of generated colors may typically be captured in the reflections as well. A few changes in colors may be observed due to the background lighting conditions of the user 110 and a quality of the imaging sensor 104A.

At step 314, the average change in color may be checked to be within a predefined range. In accordance with some embodiments, the processor 202 may be configured to check the average change in color to be within the predefined range. In an embodiment, the processor 202 may determine the predefined range based on the HSL values of the set of generated colors. For example, the predefined range may be determined by use of a “NumPy array”. Such a predefined range enables detection of change (or a difference) in the color values of the set of generated colors and the set of reflected colors (i.e., the color change before and after the reflection).

At step 316, in case the average change in color may be found outside the predefined range, it may imply that the set of reflected colors may be different that the set of generated colors, and thus, the average change in color may be invalidated and the verification fails. In an embodiment, the processor 202 may be configured to again go to step 304 and may detect the eye coordinates. Such a step may be performed to minimize false negatives. If the average change in color may still be found outside the predefined range even after one or more attempts, the verification process may stop and the user 110 may be identified as a spoofed user.

At step 318, in case the average change in color may be found within the predefined range, the average change in color may be validated. In such a scenario, the rate of change of pattern may be determined. In accordance with some embodiments, the processor 202 may be configured to determine the rate of change of pattern associated with the generated adoptive color pattern and the reflected color pattern to calculate the liveness score. The rate of change of pattern may indicate how fast the reflected color pattern is captured by the imaging sensor 104A once the adoptive color pattern is shown on the display 104B.

Such rate of change of pattern may be determined because it may be practically impossible to replicate the adoptive color pattern in the real-time or the near real-time in case the user 110 may be the spoofed user (such as a deepfake video). In case of the spoofed user, the adoptive color pattern may not be seen in the reflections of the iris of the spoofed user. Only if the user 110 may be the live user, the adoptive color pattern on the display 104B may be reflected in the iris 408 in the real-time or the near real-time.

In some embodiments, the processor 202 may be configured to determine the rate of change of pattern based on a first set of time instants associated with the set of generated colors and a second set of time instants associated with the set of reflected colors. For instance, the set of generated colors in the generated adoptive color pattern may include “n” no. of colors identified based on the color composition of the iris 408. In such a case, the “n” no. of colors may be shown on the display 104B at the first set of time instants, such as at: t₁, t₃, t₅, . . . , tₙ. Moreover, the set of reflected colors may be captured at the second set of time instants, such as at: t₂, t₄, t₆, . . . , tₙ₊₁. The difference between the first set of time instants and the respective second set of time instants may be calculated to determine the rate of change of pattern. Further, the processor 202 may be configured to calculate the liveness score associated with the user 110 based on the rate of change of pattern. In some embodiments, the liveness score may be a binary number such as either 1 or 0.

In accordance with some embodiments, the processor 202 may be configured to calculate the liveness score based on at least the determined rate of change of pattern, an overall threshold associated with a time delay between the first set of time instants and the second set of time instants, and an absolute threshold associated with the time delay between the first set of time instants and the second set of time instants. An exemplary mathematical formula to calculate the liveness score is described with respect to following equation 1:

$$Liveliness score = \prod ( max ( 0 , sign ( {t}_{i} - {t}_{i + 1} ) ) ) * ( true ( ( max ( {t}_{i} - {t}_{i + 1} ) \leq ( \frac{\sum ( {t}_{i} - {t}_{i + 1} )}{2 n} + ( \frac{\sum ( {t}_{i} - {t}_{i + 1} )}{2 n * \frac{k}{100}} ) ) and ( min ( {t}_{i} - {t}_{i + 1} ) \geq ( \frac{\sum ( {t}_{i} - {t}_{i + 1} )}{2 n} - ( \frac{\sum ( {t}_{i} - {t}_{i + 1} )}{2 n * \frac{k}{100}} ) ) ) * 1 ) * ( true ( ( \sum \frac{( {t}_{i + 1} - {t}_{i + 3} )}{n} - \sum ( \frac{( {t}_{i} - {t}_{i + 2} )}{n} ) \leq a ) * 1 ) \qquad ( 1 )$$

where “k” represents the % overall threshold associated with the time delay between the first set of time instants and the second set of time instants. The overall threshold may be an overall (or a maximum) threshold for the allowed time delay between the set of generated colors and the corresponding set of reflected colors. In other words, the time delay may ideally be below the overall threshold.

Moreover, “a” represents the absolute threshold in timeframe delay, i.e., the time delay between the first set of time instants and the second set of time instants. In an embodiment, the absolute threshold may be, for example, 30 milliseconds. “i” may represent a series of “n” in the order of 1, 3, 5, . . . n.

At step 320, the liveness score may be checked. In accordance with some embodiments, the processor 202 may be configured to check the liveness score of the user 110. The liveness score may be used to determine that the user 110 may be either the live user or the spoofed user. In case, the liveness score may be =0, the verification fails. In case the liveness score may be =1, the rate of change of pattern may be validated.

In some embodiments, the passive liveness detection may be performed based on the liveness score itself. In such a case, the processor 202 may be configured to determine the verification status of the user 110 based on the calculated liveness score itself. In an embodiment, if the liveness score may be =1, the user 110 may be verified as the live user and the verification status may be determined as a successful verification. In another embodiment, if the liveness score may be =0, the user 110 may be verified as the spoofed user and the verification status may be determined as a failed verification. However, in case prestored blink pattern associated with the user 110 may be available, the processor 202 may be configured to utilize the prestored blink pattern in addition to the liveness score to determine the verification status of the user 110.

Referring to FIG. 3B, at step 322, availability of the prestored blink pattern may be checked. In accordance with some embodiments, the processor 202 may be configured to check if the prestored blink pattern may be available. In an embodiment, the prestored blink pattern may be available in the database 106 or the memory 204. For example, the user 110 may have utilized the system 102 previously as well for the remote authentication purposes. In some embodiments, the system 102 may ask for a consent from the user 110 to record the blink pattern that may be stored in the database 106 or the memory 204 for future references. In such a manner, the prestored blink pattern may be utilized for the liveness detection along with the rate of change of pattern.

In case the prestored blink pattern may unavailable, the processor 202 may be configured to go to step 324. In case the prestored blink pattern may unavailable and the liveness score may be 0, the verification may fail. In such a case, the user 110 may be determined as the spoofed user.

At step 326, in case the prestored blink pattern may unavailable and the liveness score may be 1, the verification may be successful and the verification status of the suer 110 may be determined as the live user.

In case the prestored blink pattern may be available, the processor 202 may go directly from the step 322 to step 328. At step 328, in case the prestored blink pattern may be available, the processor 202 may be configured to detect the blink pattern of the eyes 406 of the user 110 in the real-time or the near real-time. It may be noted that the blink pattern may be utilized as each individual may have a different blink pattern. The processor 202 may utilize such a property to determine if the user 110 may be the live user or the spoofed user. In an embodiment, the processor 202 may be configured to detect the blink pattern based on the plurality of images of the face 402 of the user 110. Further, in an embodiment, the processor 202 may be configured to compute an eye aspect ratio (EAR) associated with the eye 406 of the user 110 from the plurality of images to detect the blink pattern. An exemplary scenario for the computation of the EAR and the blink pattern detection is described in FIG. 5.

FIG. 5 illustrates an exemplary diagram 500 depicting blink pattern detection, in accordance with some embodiments of the present disclosure. FIG. 5 is explained in conjunction with elements of FIG. 1, FIG. 2, FIG. 3A, FIG. 3B and FIG. 4.

The exemplary diagram 500 may include a plurality of images 502 of the face 402 of the user 110. The plurality of images 502 may include an image 502A, an image 502B, an image 502C and an image 502N. The exemplary diagram 500 may further include the eye 406 of the user 110. The eye 406 may include depicted landmarks 504. The landmarks 504 may include a first horizontal landmark 504A, a second horizontal landmark 504B, a first vertical landmark 504C and a second vertical landmark 504D. In an embodiment, the image 404 may be a part of the plurality of images 502.

In an embodiment, the processor 202 may be configured to determine a movement of eyelids of the user 110 based on the landmarks 504 to detect the blink pattern of the user 110. The EAR may be used to determine whether the eye 406 may be open or closed based on a ratio of Euclidean distances between two sets of horizontal eye landmarks (such as the first horizontal landmark 504A and second horizontal landmark 504B) and vertical eye landmarks (such as the first vertical landmark 504C and the second vertical landmark 504D). In an example, the EAR may be calculated for both the eyes of the user 110 and an average EAR may be derived. The EAR may be computed for one or more of the plurality of images 502. For an image of the plurality of images 502, in case a value of the EAR may be close to 0, it may indicate that the eyes may be closed.

Referring again to FIG. 3B, at step 330, a set of variables may be determined. In accordance with some embodiments, the processor 202 may be configured to determine the set of variables based on the EAR and the plurality of images 502 to detect the blink pattern. In an embodiment, the set of variables may include a variable “EAR threshold”, a variable “counter value”, a variable “EYE frames” and a variable “total blinks”.

The variable “EAR threshold” may be for example, a threshold to determine a blink of the eyes of the user 110. The EAR threshold may be defined as a maximum value below which the eyes may be considered close. The variable “counter value” may indicate a number of consecutive images of the plurality of images 502 in which the eyes of the user 110 may be closed. The variable “eye frames” may indicate a number of consecutive images where the computed EAR may be below the EAR threshold for the blink detection. The variable “total blinks” may indicate the number of blinks that may be detected in the plurality of images 502.

At step 332, the EAR may be determined to be less than one or more of the set of variables. In accordance with some embodiments, the processor 202 may be configured to determine the EAR to be less than one or more of the set of variables. The determination of the EAR to be less than one or more of the set of variables is described with respect to FIG. 5.

Referring again to FIG. 5, the processor 202 may compute the EAR for a first frame, i.e., the image 502A. In an embodiment, the processor 202 may be configured to compute the EAR for both eyes of the user 110 separately and derive an average EAR (hereinafter referred to as EAR) for the eyes of the user 110. Again, the processor 202 may compute the EAR for a second frame, i.e., the image 502B. The processor 202 may continue computing the EAR for consecutive images in which the computed EAR is found to be less than the EAR threshold. Once the EAR may be found to be more the EAR threshold, the computation of the EAR may be stopped.

In an exemplary scenario, the EAR threshold may be 0.3. Thus, until the computed EAR is found to be more than “0.3”, the processor 202 may compute the EAR for the consecutive images. As EAR close to the value 0 may indicate that the eyes may be closed, thus, such a computation may provide a total number of consecutive images of the plurality of images 502 in which the eyes of the user 110 may be closed. For example, for the image 502A, the EAR may be 0.21, for the image 502B, the EAR may be 0.26, and for the image 50C, the EAR may be 0.35. In such a case, the EAR indicates that in the image 502A and the image 502B, the eyes of the user 110 may be closed. The EAR further indicates that in the image 502C, the eyes of the user 110 may be open.

Further, for each image the computed EAR is found to be less than the EAR threshold, the counter value is increased by 1. In other words, the counter value may be increased by 1 for each image till the EAR is found to be less than the EAR threshold, which may signify that the counter value is increased by 1 for each image of the plurality of images 502 in which the eyes are closed. Thus, referring to the exemplary scenario, the counter value may be incremented by 1 for the image 502A and again may again be incremented for the image 502B. This would provide the number of consecutive images (corresponding to the counter value) in the plurality of images 502 in which the eyes of the user 110 may be closed.

Further, in an example, the variable eye frames may be set to “3”. In an embodiment, the processor 202 may be configured to compare the counter value with the eye frames. The eye frames may indicate the number of consecutive images for which the EAR must be less than the EAR threshold to be considered that the eyes may be closed. When the counter value may be equal to or more than the eye frames, it may be concluded that the blink may be detected. Further, after the blink may be detected, the variable total may be increased by 1, to keep a track of the number of blinks detected in the plurality of images 502. Once the variable total may be increased by 1, the variable counter may be reset to 0. After resetting, the EAR may again be computed for the next consecutive images of the plurality of images 502.

The blink detection may be explained in other words as: The processor 202 may check the EAR for each of the plurality of images 502 one by one. For each image, the counter is increased by 1 (Counter=counter+1) in which the EAR is found to be less than the EAR threshold (EAR<EAR threshold). The processor 202 may set the eye frames value (e.g., 3). When the counter value is more than the eye frames value (counter>eye frames), the blink may be detected. The variable “total” may be increased by 1 and the variable “counter” may be reset to 0 once the blink may be detected. After resetting, the EAR may again be computed for the next consecutive images of the plurality of images 502. In some embodiments, in case the EAR may not be found less than the EAR threshold for any image of the plurality of images 502, the verification may fail. In such a case, the verification status of the user 110 may be determined as the spoofed user.

Referring again to FIG. 3, at step 334, the detected blink pattern may be matched with the prestored blink pattern. In accordance with some embodiments, the processor 202 may be configured to match the prestored blink pattern with the detected blink pattern. In case the prestored blink pattern does not match with the detected blink pattern, the verification may fail. In such a case, the verification status of the user 110 may be determined as the spoofed user.

At step 336, in case the prestored blink pattern matches with the detected blink pattern and the liveness score may be 0, the verification may fail. In such a case, the user 110 may be determined as the spoofed user. Further, in case the prestored blink pattern matches with the detected blink pattern and the liveness score may be 1, the processor 202 may be configured to move to the step 324 and the verification may be successful. In such a case, the verification status of the user 110 may be determined as the live user.

FIG. 6 shows an exemplary flow chart illustrating a method 600 for passive liveness detection, in accordance with some embodiments of the present disclosure. FIG. 6 is explained in conjunction with elements of FIG. 1, FIG. 2, FIG. 3A, FIG. 3B, FIG. 4 and FIG. 5.

As illustrated in FIG. 6, the method 600 may comprise one or more steps. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 602, the method may include identifying the color composition of the iris 408 of the user 110. In accordance with some embodiments, the processor 202 may be configured to identify the color composition of the iris 408 of the user 110. In an example, the processor 202 may identify the color composition of the iris 408 of the user 110 based on the pixel analysis of the located iris 408. Details of the identifying the color composition are further described, for example, in FIG. 3A.

At step 604, the method may include generating the adoptive color pattern on the display 104B of the user device 104 based on the identified color composition. In accordance with some embodiments, the processor 202 may be configured to generate the adoptive color pattern on the display 104B of the user device 104 based on the identified color composition. For example, the adoptive color pattern may be generated by use of the ML model 202A. Details of the generation of the adoptive color pattern are further described, for example, in FIG. 3A.

At step 606, the method may include capturing the reflected color pattern corresponding to the generated adoptive color pattern from the iris 408 of the user 110. In accordance with some embodiments, the processor 202 may be configured to capture the reflected color pattern corresponding to the generated adoptive color pattern from the iris 408 of the user 110. For example, the processor 202 may trigger the imaging sensor 104A to capture the reflected color pattern. Details of the capturing the reflected color pattern are further described, for example, in FIG. 3A.

At step 608, the method may include determining the rate of change of pattern associated with the generated adoptive color pattern and the reflected color pattern to calculate the liveness score. In accordance with some embodiments, the processor 202 may be configured to determine the rate of change of pattern associated with the generated adoptive color pattern and the reflected color pattern to calculate the liveness score. Details of the determining the rate of change of pattern to calculate the liveness score are further described, for example, in FIG. 3A.

At step 610, the method may include determining the verification status of the user 110 based on at least the calculated liveness score. In accordance with some embodiments, the processor 202 may be configured to determine the verification status of the user based on at least the calculated liveness score. For example, in case the liveness score=1, the verification status may be the live user, and in case the liveness score=0, the verification status may be the spoofed user. Details of the determining the verification status of the user 110 are further described, for example, in FIG. 3A.

Further, the passive liveness detection performed by the proposed system may be compared with the conventional methodologies to describe exemplary results corresponding to accuracy of the proposed system. A following Table 1 depicts the exemplary results:

TABLE 1
Exemplary results of the proposed system for passive liveness detection

| | Type of spoofing attempt | | | |
|---|---|---|---|---|
| | (Accuracy % of successfully identifying fake authentication) | | | |
| | | | Generative | Generative AI based |
| | | Video | AI based | deepfake when pattern |
| Methodology | Image | stream | deepfake | may be already known |
| Active liveliness test | 99.99 | 90 | 85 | <20 |
| Existing Passive | 90 | 30 | <20 | <20 |
| liveliness test | | | | |
| Proposed system for | 99.99 | 99.99 | 95 | 95 |
| passive liveness | | | | |
| detection | | | | |

The proposed system has been tested with various spoofing attempt scenarios, for example, a spoofed image, a spoofed video, a generative AI based deepfake of the user, and a generative AI based deepfake where the generated adoptive pattern may already be known. The exemplary results in the Table 1 may depict that the proposed system may be more accurate and efficient than the conventional methodologies in case of all types of the spoofing attempts.

Furthermore, the proposed system may be implemented for the remote user verification solutions such as electronic-know your customer (e-KYC), facial authentication, and the like. The proposed system may ensure that the user being identified is the live or an authentic person and not any of the spoofed media. Following are some key applications where the proposed system may be utilized:

A) Digital account opening (e-KYC): The proposed system may be utilized to enhance a security of the e-KYC process. For example, proposed system may be used to verify the users during an account opening process on digital platforms, ensuring that the user undergoing the e-KYC process may actually be the live user and not the spoofed user.

B) Facial authentication method: The facial authentication method may be performed using the proposed system to confirm an identity of the user. The facial authentication method may involve capturing the live image or the video of the face of the user and analyzing various facial features such as the color of the iris. The proposed system may provide the identification of the color of the iris as well as accurately determining that the user may be the live user in the real-time or the near real-time. Thus, the proposed system may be deployed in the remote authentication systems requiring high level speed and accuracy.

C) Transaction authorization: The proposed system may be implemented for the transaction authorizations. For example, the passive liveliness checks may be performed before processing high-value transactions. In such a manner, an extra layer of security may be added in the transaction systems, ensuring that transaction requests may be initiated by a legitimate account holder and not by someone using the deepfake technology to mimic the user.

D) Loan application and disbursement: During the remote application process for loans, the proposed system may be used as part of the verification process. In such a manner, a probability of frauds may significantly be reduced, thereby, ensuring that the loan may be disbursed to the authorized individual.

E) Credit and debit card activation: Before activating a new credit or a debit card through a mobile banking application, the proposed system may be utilized for the passive liveliness test. In such a manner, it may be ensured that the credit card or the debit card may be activated by a legitimate cardholder only, reducing the risk of card fraud.

F) Secure Access to Financial Documents: When accessing sensitive financial documents online, such as bank statements or investment reports, the proposed system may be utilized to perform the passive liveliness test that may be used to verify the user, ensuring that only the account holder or authorized individuals have access to such sensitive financial documents.

G) Government Services: For instance, the proposed system may be utilized to access government portals, issuing electronic documents, signing off key documents such as company filing documents, stock market Management discussion and analysis (MD&A) reports filing and verifying the identity of the user for social programs to ensure the user interacting with the system is legitimate.

H) Border Security: For example, airports and border crossings may utilize the proposed system for the facial recognition checks to verify travel documents and prevent impersonation of the users.

I) User logins and account verification: Many social media platforms and mobile applications may deploy the proposed system for the user logins and account verification. In such a manner, a seamless user experience may be provided to the user while adding a layer of security.

J) Electronic (e)-commerce transactions: For instance, online retailers may utilize the proposed system during checkout processes to reduce a risk of fraudulent purchases and ensure that the cardholder making the payment may physically be present to make the payment.

K) Remote access systems: For example, businesses may utilize the proposed system for secure remote access to company servers and resources, ensuring only authorized individuals may gain entry.

L) Medical identity theft protection: In an embodiment, both active liveness tests and the proposed system for the passive liveness tests may be integrated for processing medical insurance claims to reduce the risk of fraudulent claims submitted under a stolen identity.

M) Secure access to medical records: Hospitals and insurance companies may utilize the proposed system to grant patients secure access to electronic medical records, protecting sensitive health information.

N) Accessibility for elderly or disabled: For instance, the active liveliness tests requiring specific movements may be difficult for some elderly or disabled individuals. In such a case, the proposed system may be utilized to ensure inclusivity.

In a similar manner, the proposed system may be utilized for applications other than the applications mentioned as well.

It may be noted that, one or more computer readable medium may be utilized in implementing embodiments consistent with the present disclosure. A computer readable medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the technology.

When a single device, system or article is described herein, it will be readily apparent that more than one device/article (whether or not they cooperate) may be used in place of the single device, the system or the article. Similarly, where more than one device, system or article is described herein (whether or not they cooperate), it will be readily apparent that a single device, system or article may be used in place of the more than one device, system or article or a different number of devices, systems, articles may be used instead of the shown number of devices, systems, articles or programs. The functionality and/or the features of a device or a system may be alternatively embodied by one or more other devices or systems which are not explicitly described as having such functionality/features. Thus, other embodiments of the technology need not include the device itself.

The illustrated operations of FIG. 3A, FIG. 3B and FIG. 6 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the technology be limited not by this detailed description, but rather by any claims that issue on an application based here on. Accordingly, the disclosure of the embodiments of the technology is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A system for passive liveness detection, the system comprising:
a processor; and
a memory, communicatively coupled to the processor, wherein the memory stores processor-executable instructions, which, on execution, causes the processor to:
identify a color composition of an iris of a user;
generate an adoptive color pattern on a display of a user device based on the identified color composition;
capture a reflected color pattern corresponding to the generated adoptive color pattern from the iris of the user;
determine a rate of change of pattern associated with the generated adoptive color pattern and the reflected color pattern to calculate a liveness score; and
determine a verification status of the user based on at least the calculated liveness score.

2. The system of claim 1, wherein the processor is further configured to:
capture a plurality of images of a face of the user via an imaging sensor of the user device; and
determine eye coordinates from the plurality of images, to locate the iris of the user.

3. The system of claim 2, wherein the processor is further configured to perform pixel analysis of the located iris to identify the color composition of the iris of the user.

4. The system of claim 1, wherein the processor is configured to utilize a machine learning (ML) model to generate the adoptive color pattern based on the identified color composition of the iris, wherein the adoptive color pattern comprises a set of generated colors complementary to the color composition of the iris.

5. The system of claim 1, wherein the processor is further configured to:
compute an average change in color between a set of generated colors in the adoptive color pattern and a corresponding set of reflected colors in the reflected color pattern; and
determine the rate of change of pattern based on a determination that the computed average change in color is found to be within a predefined range.

6. The system of claim 5, wherein the processor is further configured to determine the rate of change of pattern based on a first set of time instants associated with the set of generated colors and a second set of time instants associated with the set of reflected colors.

7. The system of claim 6, wherein the processor is configured to calculate the liveness score based on at least: the determined rate of change of pattern, an overall threshold associated with a time delay between the first set of time instants and the second set of time instants, and an absolute threshold associated with the time delay between the first set of time instants and the second set of time instants.

8. The system of claim 1, wherein the processor is configured to determine the verification status as a successful verification based on the calculated liveness score indicating the user as a live user.

9. The system of claim 1, wherein the processor is configured to determine the verification status as a failed verification based on the calculated liveness score indicating the user as a spoofed user.

10. The system of claim 1, wherein the processor is further configured to:
detect a blink pattern of eyes of the user based on a plurality of images of a face of the user; and
determine the verification status of the user based on the detected blink pattern and the calculated liveness score.

11. The system of claim 10, wherein the processor is further configured to:
compute an eye aspect ratio associated with the eyes of the user; and
determine a set of variables based on the eye aspect ratio and the plurality of images of the user to detect the blink pattern.

12. The system of claim 10, wherein the processor is further configured to:
match the detected blink pattern with a prestored blink pattern associated with the user; and
determine the verification status as a successful verification based on successful matching of the detected blink pattern and the prestored blink pattern.

13. A method for passive liveness detection, comprising:
identifying a color composition of an iris of a user;
generating an adoptive color pattern on a display of a user device based on the identified color composition;
capturing a reflected color pattern corresponding to the generated adoptive color pattern from the iris of the user;
determining a rate of change of pattern associated with the generated adoptive color pattern and the reflected color pattern to calculate a liveness score; and
determining a verification status of the user based on at least the calculated liveness score.

14. The method of claim 13, further comprising:
capturing a plurality of images of a face of the user via an imaging sensor of the user device; and
determining eye coordinates from the plurality of images, to locate the iris of the user.

15. The method of claim 14, further comprising performing pixel analysis of the located iris to identify the color composition of the iris of the user.

16. The method of claim 13, further comprising utilizing a machine learning (ML) model for generating the adoptive color pattern based on the identified color composition of the iris, wherein the adoptive color pattern comprises a set of generated colors complementary to the color composition of the iris.

17. The method of claim 13, further comprising:
computing an average change in color between a set of generated colors in the adoptive color pattern and a corresponding set of reflected colors in the reflected color pattern; and
determining the rate of change of pattern based on a determination that the computed average change in color is found to be within a predefined range.

18. The method of claim 17, further comprising determining the rate of change of pattern based on a first set of time instants associated with the set of generated colors and a second set of time instants associated with the set of reflected colors.

19. The method of claim 18, further comprising calculating the liveness score based on at least: the determined rate of change of pattern, an overall threshold associated with a time delay between the first set of time instants and the second set of time instants, and an absolute threshold associated with the time delay between the first set of time instants and the second set of time instants.

20. A non-transitory computer readable medium including instruction stored thereon that when processed by at least one processor cause the system to perform operations comprising:
identifying a color composition of an iris of a user;
generating an adoptive color pattern on a display of a user device based on the identified color composition;
capturing a reflected color pattern corresponding to the generated adoptive color pattern from the iris of the user;
determining a rate of change of pattern associated with the generated adoptive color pattern and the reflected color pattern to calculate a liveness score; and
determining a verification status of the user based on at least the calculated liveness score.
